(19) United States
(12) Patent Application Publication
(10) Pub. No.: US 2003/0037643 A1
(43) Pub. Date: Feb. 27, 2003

(54) Expandable handle for a rotational tool

(76) Inventor: Jeffrey Hess, Plymouth, UT (US)

Correspondence Address: FEHR LAW FIRM, Goldenwest Corporate Center, Suite 300, 5025 Adams Avenue, Ogden, UT, 84403, US

(21) Appl. No.: 09/934,109

(22) Filed: Aug. 21, 2001

(51) Int. Cl. B25B 23/16

(52) U.S. Cl. 81/177.5

(57) ABSTRACT

An expandable handle for a rotational tool having two end segments of a handle. The end segments are rotatably attached to the body of the handle. In one embodiment, the end segments rotate in the same plane. In a second embodiment, the end segments rotate in parallel planes. The first embodiment preferably employs magnets in the end segments to keep such end segments aligned when an expansion of the handle is not desired. The second embodiment preferably achieves this goal by having a channel channel on a first end segment and a complementary extension on a second end segment.

### BACKGROUND OF THE INVENTION

1. Field of the Invention

This invention relates to hand tools in general and, more particularly, to a driver for the manual turning of a rotary fastener.

2. Description of the Related Art

A variety of tools are employed to exert rotational forces on different fasteners in order to attach or to disengage such fasteners.

As examples, some common fasteners are screws and bolts. Examples of the tools used to attach screws and bolts are screwdrivers and wrenches. Wrenches for which the current invention is applicable are those whose handle is parallel to the shaft of the wrench and perpendicular to the desire plane of rotation for the head of the fastener, i.e., those wrenches which resemble the traditional screwdriver.

Such rotational tools establish a mechanical advantage which is equal to the diameter of the portion of the handle that is in contact with the user's hand divided by the portion of the working element which is in contact with the head of the fastener.

Many inventions apply to handles for such tools which increase this mechanical advantage by increasing the diameter of the portion of the handle that is in contact with the user's hand.

Some handles simply have a fixed handle with a larger diameter, often being L-shaped or T-shaped. Examples of such handles are included within U.S. Pat. Nos. 4,787,276; 5,822,830; 6,151,997; and 6,151,998.

Other handles have a single element that rotates to form and L-shaped or T-shaped handle. Examples of this version of the handle are the subjects of U.S. Pat. Nos. 4,196,761; 4,235,269; 4,893,529; 5,069,091; 5,101,696; 5,450,775; 5,943,925; 6,058,812; 6,095,018; 6,101,909; 6,116,123; 6,189,420; and 6,230,593.

And the handle of U.S. Pat. No. 4,768,406 can change its cross-sectional shape in response to increased torque.

None of these patents, though, produce a greater mechanical advantage by rotating two end segments of a handle.

### SUMMARY OF THE INVENTION

The present invention achieves a heightened mechanical advantage by rotating two end segments of a handle.

In one embodiment the end segments rotate in parallel planes.

In another embodiment the end segments rotate toward and away from each other in the same plane.

### BRIEF DESCRIPTION OF THE DRAWINGS

FIG. 1 depicts

### DESCRIPTION OF THE PREFERRED EMBODIMENT

A first end 1 of a handle 2 which is opposite to the working element is constructed of a first end segment 3 and a second end segment 4. The first end segment 3 and the second end segment 4 are pivotally connected to the handle body 5 so that the first end segment 3 and the second end segment 4 may rotate with respect to one another until each reaches a stop 6 on the handle body 5.

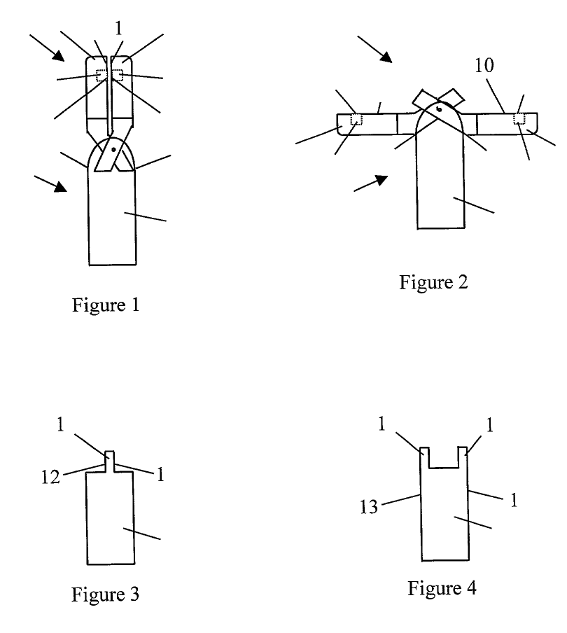

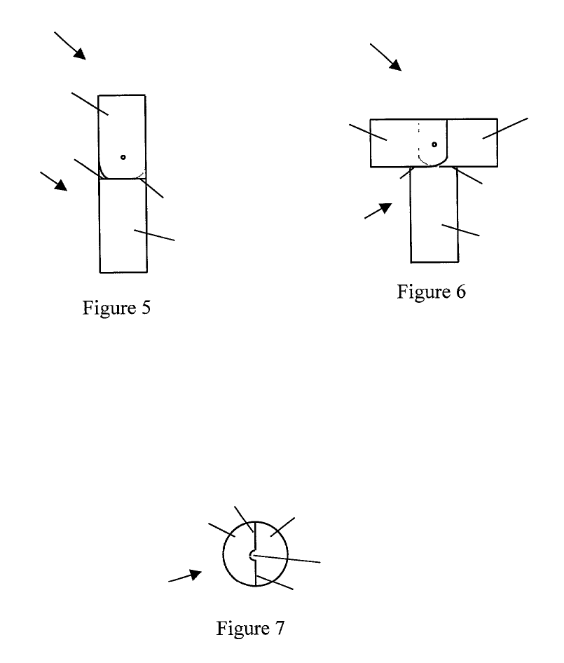

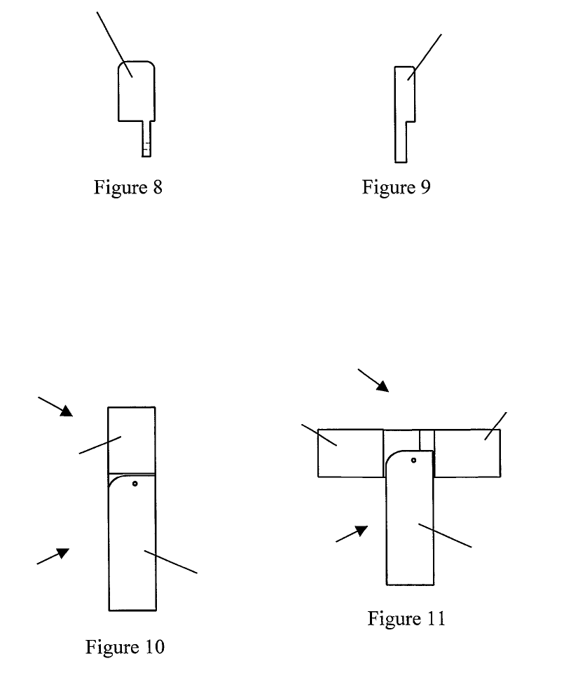

In a first embodiment, depicted in FIG. 1 and FIG. 2, the first end segment 3 and the second end segment 4 rotate in the same plane. To expand the diameter of the rotational tool, the first end segment 3 and the second end segment 4 rotate in opposite directions; to return the diameter of the rotational tool to its original dimension, the first end segment 3 and the second end segment 4 rotate toward each other until they touch. Preferably, the first end segment 3 contains a magnet 7 having a magnetic pole 8 on the side 9 of the first end segment 3 that is directed generally toward the second end segment 4 when the first end segment 3 and the second end segment 4 are substantially aligned with one another and the handle body 5; and the second end segment 4 contains a magnet 7 having a magnetic pole 8 of opposite polarity on its side 10 which is directed generally toward the first end segment 3 when the first end segment 3 and the second end segment 4 are substantially aligned with one another, in order releasably to connect the first end segment 3 to the second end segment 4.

In a second embodiment, illustrated in FIG. 5 and FIG. 6, the first end segment 3 and the second end segment 4 rotate in parallel planes.

For both embodiments, the rotational attachment of the first end segment 3 and the second end segment 4 to the body 5 of the handle 2 may be to a single raised projection 11, as shown in FIG. 3 (in which case the portion of the first end segment 3 which is rotatably attached to the body 5 of the handle 2 and the portion of the second end segment 4 which is rotatably attached to the body 5 of the handle 2 would be on the outer sides 12 of the single raised projection 11), or to two raised projections 11 aligned with the outer extremity 13 of the body 5 of the handle 2, as portrayed in FIG. 4 (in which case the portion of the first end segment 3 which is rotatably attached to the body 5 of the handle 2 and the portion of the second end segment 4 which is rotatably attached to the body 5 of the handle 2 would lie between such two raised projections 11).

If the handle 2 were transparent, FIG. 1 and FIG. 2 could depict—for the first embodiment—either the situation where there is a single raised projection 11 or the case where there are two raised projections 11.

For the second embodiment, FIG. 5 and FIG. 6 illustrate the situation where there is a single raised projection 11; FIG. 10 and FIG. 11 exhibit the handle with two raised projections 11.

FIG. 7 depicts the second embodiment viewed from above to illustrate the option of having on the side 9 of the first end segment 3 which is directed generally toward the second end segment 4 when the first end segment 3 and the second end segment 4 are substantially aligned with one another and the handle body 5 a channel 14 which accommodates an extension 15 on the side 10 of the second end segment 4 which is generally oriented toward the first end segment 3 when the first end segment 3 and the second end segment 4 are substantially aligned with one another and the handle body 5, removably to connect the first end segment 3 to the second end segment 4. This channel 14 provides a releasable connection for the end segments 3,4 while also precluding any unwanted outward extension of the first end segment 3 and the second end segment 4. And, of course, an alternate method for releasably connecting the end segments 3,4 of the second embodiment is the magnetic method described with respect to the first embodiment.

Finally, FIG. 8 shows an end segment 3 or 4 for the first embodiment for use with a single raised projection 11 on the body 5 of the handle 2; and FIG. 9 demonstrates an end segment 3 or 4 for the second embodiment to be employed with two raised projections 11 on the body of the handle.

I claim:

1. An expandable handle for a rotational tool, which comprises:
a handle body having one or more stops;
a first end segment pivotally connected to said handle body; and
a second end segment pivotally connected to said handle body.

2. An expandable handle for a rotational tool, which comprises:
a handle body having one or more stops;
a first end segment pivotally connected to said handle body; and
a second end segment pivotally connected to said handle body, wherein said first end segment and said second end segment rotate in the same plane.

3. The expandable handle for a rotational tool as recited in claim 2, further comprising:
a means for releasably connecting said first end segment to said second end segment.

4. The expandable handle for a rotational tool as recited in claim 3, wherein:
the means for releasably connecting said first end segment to said second end segment comprises:
a magnet in said first end segment having a magnetic pole oriented generally toward the position of said second end segment when said first end segment and said second end segment are substantially aligned with one another and said handle body; and
a magnet in said second end segment having a magnetic pole of opposite polarity, to the pole in said first end segment that is oriented generally toward said second end segment, oriented generally toward the position of said first end segment when said first end segment and said second end segment are substantially aligned with one another and said handle body.

5. An expandable handle for a rotational tool, which comprises:
a handle body having one or more stops;
a first end segment pivotally connected to said handle body; and
a second end segment pivotally connected to said handle body, wherein said first end segment and said second end segment rotate in planes which are parallel to one another.

6. The expandable handle for a rotational tool as recited in claim 5, further comprising:
a means for releasably connecting said first end segment to said second end segment.

7. The expandable handle for a rotational tool as recited in claim 6, wherein:
the means for releasably connecting said first end segment to said second end segment comprises:
a magnet in said first end segment having a magnetic pole oriented generally toward the position of said second end segment when said first end segment and said second end segment are substantially aligned with one another and said handle body; and
a magnet in said second end segment having a magnetic pole of opposite polarity, to the pole in said first end segment that is oriented generally toward said second end segment, oriented generally toward the position of said first end segment when said first end segment and said second end segment are substantially aligned with one another and said handle body.

8. The expandable handle for a rotational tool as recited in claim 6, wherein:
said first end segment has a channel on a side of said first end segment which is directed generally toward said second end segment when said first end segment and said second end segment are substantially aligned with one another and said handle body; and
further comprising an extension on a side of said second end segment which is generally oriented toward said first end segment when said first end segment and said second end segment are substantially aligned with one another and said handle body.
